(19) United States
(12) Patent Application Publication
(10) Pub. No.: US 2017/0368751 A1
(43) Pub. Date: Dec. 28, 2017

(54) LIGHT CONTROL DEVICE AND MANUFACTURING METHOD THEREOF, 3D PRINTING SYSTEM

(71) Applicant: BOE TECHNOLOGY GROUP CO., LTD., Beijing (CN)

(72) Inventor: Wenbo LI, Beijing (CN)

(21) Appl. No.: 15/544,051

(22) PCT Filed: Apr. 15, 2016
(86) PCT No.: PCT/CN2016/079467

§ 371 Date: Jul. 17, 2017

(30) Foreign Application Priority Data
May 15, 2015 (CN) 201510251241.8

(51) Int. Cl. B29C 64/286; B33Y 30/00; B29C 64/135; C23F 1/02

(52) U.S. Cl. CPC B29C 64/286; B29C 64/135; B33Y 30/00; C23F 1/02

(57) ABSTRACT

The light control device includes a first polarizing plate, an array substrate, liquid crystals, an opposing substrate, and a second polarizing plate in sequence. The array substrate includes a base substrate, a pixel array, and a black matrix formed on the base substrate. The black matrix is formed at least in an area corresponding to a thin film transistor in the pixel array. The light control device is used for 3D printing of selected area curing shaping of light-cured liquid material. The light control device provided in the embodiments of the present disclosure can accurately control the area irradiated by light, using the principle of the liquid crystal display, thereby accurately curing the selected area of the light-cured liquid resin.

### CROSS REFERENCE TO RELATED APPLICATIONS

This patent application is a National Stage Entry of PCT/CN2016/079467 filed on Apr. 15, 2016, which claims the benefit and priority of Chinese Patent Application No. 201510251241.8 filed on May 15, 2015, the disclosures of which are incorporated herein in their entirety as part of the present application.

### BACKGROUND

The present disclosure relates to a technical field of 3D printing, and more particularly, to a light control device and a manufacturing method thereof, and a 3D printing system.

3D printing is a new rapid prototyping manufacturing technology. It utilizes multilayer stacking and growing of printed materials to manufacture products. 3D printing can implement a special structure that cannot be implemented by traditional machining, and can implement a simplified production for a complex structural part of any shape. Existing 3D printing technologies include hot melt plastic basic technology FDM, laser sintering shaping technology, and selected area curing shaping technology of light-cured liquid resin. The selected area curing shaping technology of light-cured liquid resin controls light to be irradiated to a selected area, so as to cure liquid resin in this area into a shape, thereby implementing 3D printing. For the selected area curing shaping technology of light-cured liquid resin, how to control the irradiated area more accurately is an urgent problem to be solved.

### BRIEF DESCRIPTION

Embodiments of the present disclosure provide a light control device, a manufacturing method thereof, and a 3D printing system, which are applicable to the selected area curing shaping technology of light-cured liquid resin, and are able to accurately control an area irradiated by light.

A first aspect of the present disclosure provides a light control device, for 3D printing of a selected area curing shaping of light-cured liquid material. The light control device includes a first polarizing plate, an array substrate, liquid crystals, an opposing substrate, and a second polarizing plate in sequence. The array substrate includes a base substrate, a pixel array, and a black matrix formed on the base substrate. The black matrix is formed at least in an area corresponding to a thin film transistor in the pixel array.

In embodiments of the present disclosure, the black matrix is formed on a surface of the base substrate facing the opposing substrate, and made of a metallic material.

In embodiments of the present disclosure, the thin film transistor has a top gate structure, and is formed above the black matrix. An insulating spacing layer is provided between the black matrix and the thin film transistor.

A second aspect of the present disclosure further provides a manufacturing method for a light control device, including forming an array substrate including a base substrate, a pixel array and a black matrix, such that the black matrix is formed at least in an area corresponding to a thin film transistor in the pixel array, arranging the array substrate and an opposing substrate oppositely to form a cell, filling the cell with liquid crystals and sealing it, forming a first polarizing plate on a surface of the array substrate away from the opposing substrate, and forming a second polarizing plate on a surface of the opposing substrate away from the array substrate.

In embodiments of the present disclosure, the step of forming an array substrate including a base substrate, a pixel array and a black matrix, such that the black matrix is formed at least in an area corresponding to a thin film transistor in the pixel array includes forming in sequence, on the base substrate, a first metal film, an insulating film, a second metal film, and a photoresist, exposing and developing the photoresist, retaining the photoresist in an area corresponding to the thin film transistor, making a thickness of the photoresist in an area, corresponding to source and drain electrodes of the thin film transistor and a data line, greater than the thickness of the photoresist in other areas, etching the first metal film, the insulating film, and the second metal film which are exposed, to form a pattern of the black matrix, ashing the photoresist, leaving only the photoresist in the area corresponding to the source and drain electrodes and the data line, etching the second metal film which is exposed, to form patterns of the source and drain electrodes and the data line, and forming patterns of an active layer, a gate insulating layer, a gate electrode, a gate line, a passivation layer, and a pixel electrode.

In embodiments of the present disclosure, the step of forming an array substrate including a base substrate, a pixel array, and a black matrix, such that the black matrix is formed at least in an area corresponding to a thin film transistor in the pixel array includes forming in sequence, on the base substrate, a first metal film, an insulating film, a second metal film, an N+ a-Si film, and a photoresist, exposing and developing the photoresist, retaining the photoresist in an area corresponding to the thin film transistor and a data line, making the thickness of the photoresist in the area, corresponding to the source and drain electrodes of the thin film transistor and the data line, greater than a thickness of the photoresist in other areas, etching the first metal film, the insulating film, the second metal film, and the N+ a-Si film which are exposed, to form the pattern of the black matrix, ashing the photoresist, leaving only the photoresist in the area corresponding to the source and drain electrodes and the data line, etching the second metal film and the N+ a-Si film which are exposed to form patterns of the source and drain electrodes, an N+ a-Si layer, and the data line, and forming patterns of an active layer, a gate insulating layer, a gate electrode, a gate line, a passivation layer, and a pixel electrode.

A third aspect of the present disclosure further provides a 3D printing system, including a backlight source, a lift rod pallet, a transparent reservoir, and a light control device of any one of the above mentioned. A light emitted by the backlight source is irradiated to the transparent reservoir through the light control device to form a print product, and the lift rod pallet is located in the transparent reservoir to move the print product.

In embodiments of the present disclosure, a side of the array substrate of the light control device is the light exit side, and a side of the opposing substrate is the light entrance side.

In embodiments of the present disclosure, the backlight source emits an ultraviolet light.

In embodiments of the present disclosure, the 3D printing system further includes a cooling device for cooling the light control device.

The embodiments of the present disclosure provide a light control device, a manufacturing method thereof, and a 3D printing system. The light control device can accurately control the area irradiated by light using the principle of the liquid crystal display, so as to accurately cure the selected area of the light-cured liquid resin.

### BRIEF DESCRIPTION OF THE DRAWINGS

In order to more clearly illustrate the technical solutions of the embodiments of the present disclosure, the drawings of the embodiments will be briefly described below. It should be understood that the drawings described below merely relate to some embodiments of the present disclosure, rather than limit the present disclosure, in which:

FIG. 1 is a schematic structural diagram of a light control device according to embodiments of the present disclosure;

FIG. 2 is a schematic structural diagram of a pixel in an array substrate of the light control device in FIG. 1;

FIG. 3 is a schematic structural diagram after step S1 of a manufacturing method for a light control device according to embodiments of the present disclosure is finished;

FIG. 4 is a schematic structural diagram after step S2 of the manufacturing method for the light control device according to embodiments of the present disclosure is finished;

FIG. 5 is a schematic structural diagram after step S3 of the manufacturing method for the light control device according to embodiments of the present disclosure is finished;

FIG. 6 is a schematic structural diagram after step S4 of the manufacturing method for the light control device according to embodiments of the present disclosure is finished;

FIG. 7 is a schematic structural diagram after step S5 of the manufacturing method for the light control device according to embodiments of the present disclosure is finished;

FIG. 8 is a schematic structural diagram after step S1 of another manufacturing method for a light control device according to embodiments of the present disclosure is finished;

FIG. 9 is a schematic structural diagram after step S2 of the another manufacturing method for the light control device according to embodiments of the present disclosure is finished;

FIG. 10 is a schematic structural diagram after step S3 of the another manufacturing method for the light control device according to embodiments of the present disclosure is finished;

FIG. 11 is a schematic structural diagram after step S4 of the another manufacturing method for the light control device according to embodiments of the present disclosure is finished;

FIG. 12 is a schematic structural diagram after step S5 of the another manufacturing method for the light control device according to embodiments of the present disclosure is finished;

FIG. 13 is a schematic structural diagram of a 3D printing system according to embodiments of the present disclosure; and

FIG. 14 is a schematic diagram of the incident light of one pixel in the 3D printing system in FIG. 13.

### DETAILED DESCRIPTION

Hereinafter, specific embodying manners of the present disclosure will be further described in detail with reference to the accompanying drawings and embodiments. The following embodiments are intended to illustrate the present disclosure, rather than limit the scope of the disclosure.

FIG. 1 is a schematic structural diagram of a light control device according to embodiments of the present disclosure. The light control device may include a first polarizing plate, an array substrate, liquid crystals, an opposing substrate, and a second polarizing plate in sequence. The array substrate includes a base substrate, a pixel array, and a black matrix formed on the base substrate. The black matrix is formed at least in an area corresponding to a thin film transistor in the pixel array.

In embodiments of the present disclosure, as shown in FIG. 1, the light control device includes a first polarizing plate 21, a second polarizing plate 26, an array substrate, an opposing substrate 25 opposed to the array substrate, and liquid crystals 24 between the array substrate and the opposing substrate 25. The array substrate includes a base substrate 22, a pixel array 23, and a black matrix 27 formed on the base substrate. The black matrix 27 is formed on the array substrate and is located in an area corresponding to a thin film transistor 231 of the pixel array 23. The first polarizing plate 21 is located on a surface of the array substrate away from the opposing substrate, and the second polarizing plate 26 is located on a surface of the opposing substrate 25 away from the array substrate. The light control device is used for 3D printing of a selected area curing shaping with a light-cured liquid material.

In embodiments of the present disclosure, the light control device can accurately control the area irradiated by light using the principle of the liquid crystal display, thereby accurately curing a selected area of the light-cured liquid resin. Since it is only necessary to control the amount of light transmitted when curing the selected area of the light-cured liquid resin, and there is no requirement for color, a transparent colorless substrate is enough for the opposing substrate, without a need for a color film. Since the opposing substrate needs no color film, in order to reduce the processes for manufacturing the opposing substrate, the black matrix 27 is formed on the array substrate. The pattern of the black matrix 27 and some layer structure of the thin film transistor 231 can be formed in the same manufacturing process (for example, lithography process using a mask, referred as a mask process). This reduces the manufacturing processes of the entire light control device, without increasing the processes of manufacturing the array substrate. The productivity is improved.

In theory, the black matrix 27 may be located above or under the thin film transistor 231. The black matrix 27 is formed on a surface of the base substrate 22 facing the opposing substrate 25, that is, under the thin film transistor 231, in order to facilitate the formation thereof in the same mask process as some layer structure of the thin film transistor 231. Due to the subsequent manufacturing processes, especially that a semiconductor layer is manufactured at the temperature of about 300 degrees, conventional black resin to manufacture the black matrix 27 cannot withstand high temperature and will be damaged. The black matrix 27 preferably adopts a metallic material in the present embodiment.

In embodiments of the present disclosure, the thin film transistor 231 has a top gate structure, that is, the source and the drain thereof are generally located at the lowermost layer and are made of metallic materials. The thin film transistor 231 is formed above the black matrix 27. An insulating spacing layer 28 is provided between the black matrix 27 and the thin film transistor 231.

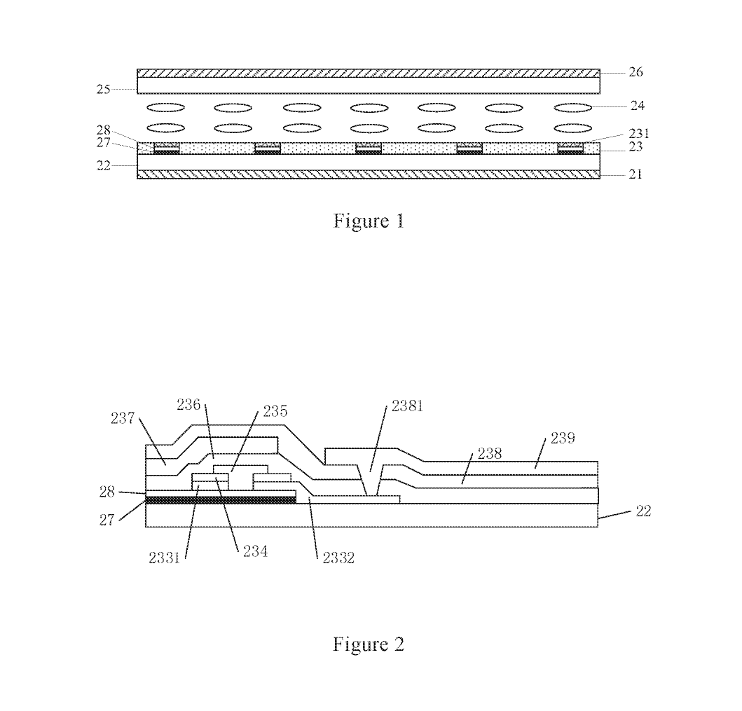

FIG. 2 is a schematic structural diagram of a pixel in the array substrate of the light control device in FIG. 1. As shown in FIG. 2, a position of the pixel structure in the array substrate includes a black matrix 27, an insulating spacing layer, a source electrode 2331, a drain electrode 2332, an N+ a-Si layer 234, an a-Si layer 235, a gate insulating layer 236, a gate 237, a passivation layer 238, a via 2381, and a pixel electrode 239 formed on the base substrate 22.

Embodiments of the present disclosure further provide a manufacturing method for the above-described light control device, including:

in step 1: forming an array substrate including a base substrate, a pixel array, and a black matrix such that the black matrix is formed at least in an area corresponding to a thin film transistor in the pixel array.

in step 2: arranging the array substrate and an opposing substrate oppositely to form a cell, filling the cell with liquid crystals and sealing the cell, forming a first polarizing plate on a surface of the array substrate away from the opposing substrate, and forming a second polarizing plate on a surface of the opposing substrate away from the array substrate.

Step 2 is substantially the same as the process of manufacturing a conventional display panel and will not be described here. Step 1 includes two following manufacturing manners.

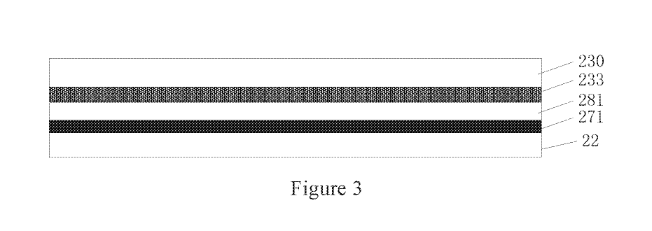

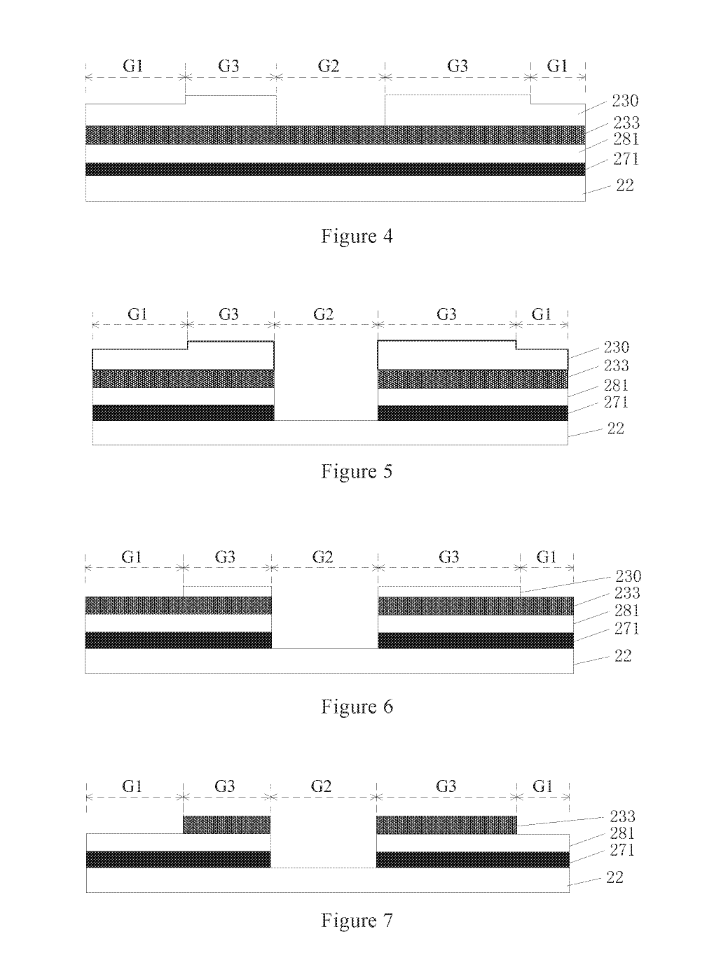

FIG. 3 is a schematic structural diagram after step S1 of the manufacturing method for the light control device according to the embodiment of the present disclosure is finished. FIG. 4 is a schematic structural diagram after step S2 of the manufacturing method for the light control device according to the embodiment of the present disclosure is finished. FIG. 5 is a schematic structural diagram after step S3 of the manufacturing method for the light control device according to the embodiment of the present disclosure is finished. FIG. 6 is a schematic structural diagram after step S4 of the manufacturing method for the light control device according to the embodiment of the present disclosure is finished. FIG. 7 is a schematic structural diagram after step S5 of the manufacturing method for the light control device according to the embodiment of the present disclosure is finished.

That is, step 1 of the first manner is shown in FIGS. 3 to 7, and includes the following steps.

In step S1, a first metal film 271, an insulating film 281, a second metal film 233, and a photoresist 230 are formed in sequence on the base substrate 22.

In step S2, the photoresist 230 is exposed and developed, and specifically, the photoresist 230 is exposed and developed using a dual-tone mask plate (a half-tone mask plate or a gray-tone mask plate). The photoresist 230 in the area corresponding to the thin film transistor and in the area corresponding to the data line (the areas other than G2 in the figure) is retained, and the thickness of the photoresist 230 in the area corresponding to the source and drain electrodes of the thin film transistor (G3) and in the area corresponding to the data line (G3) is made to be larger than that of the photoresist 230 in the other area G1.

In step S3, the first metal film 271, the insulating film 281, and the second metal film 233 which are exposed are etched to form a structure as shown in FIG. 5, and the pattern of the black matrix is formed at the time. During etching, the exposed second metal film 233 is etched firstly by a wet etching method, then the insulating film 281 is etched by a dry etching method, and finally the first metal film 271 is etched by a wet etching method.

In step S4, the photoresist 230 is ashed to retain only the photoresist 230 corresponding to the source and drain electrode area G3 and the data line area G3.

In step S5, the exposed second metal film 233 is etched to form patterns of the source and drain electrodes and the data line, that is, the structure in FIG. 7.

In step S6 (not shown), patterns including an active layer, a gate insulating layer, a gate electrode, a gate line, a passivation layer, and a pixel electrode are formed on the basis of FIG. 7, to form a final array substrate structure. The forming manner thereof is similar to that for a conventional substrate, and will not be described here.

In the above manufacturing process, the black matrix, the insulating spacing layer and the source and drain electrodes are formed in a one mask process. The manufacturing procedures are saved.

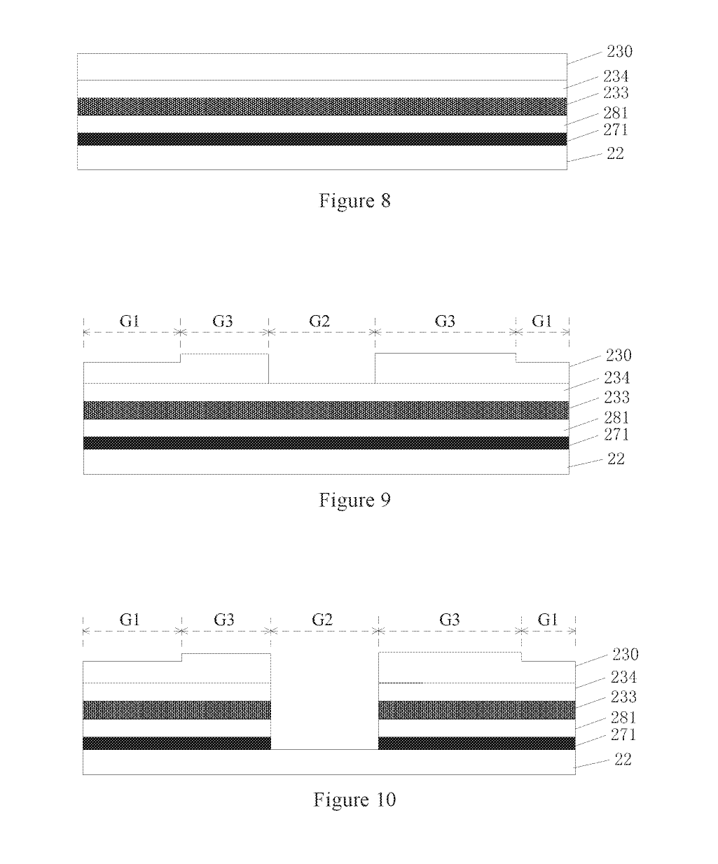

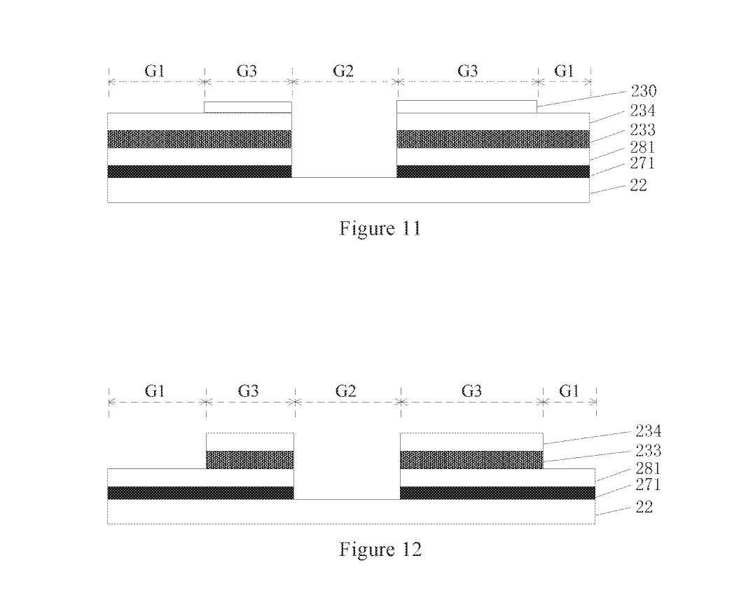

FIG. 8 is a schematic structural diagram after step S1 of another manufacturing method for a light control device according to embodiments of the present disclosure is finished. FIG. 9 is a schematic structural diagram after step S2 of the another manufacturing method for the light control device according to the embodiment of the present disclosure is finished. FIG. 10 is a schematic structural diagram after step S3 of the another manufacturing method for the light control device according to the embodiment of the present disclosure is finished. FIG. 11 is a schematic structural diagram after step S4 of the another manufacturing method for the light control device according to the embodiment of the present disclosure is finished. FIG. 12 is a schematic structural diagram after step S5 of the another manufacturing method for the light control device according to the embodiment of the present disclosure is finished.

That is, step 1 of the second manner is as shown in FIGS. 8 to 12, and includes the following steps.

In step S1, a first metal film 271, an insulating film 281, a second metal film 233, an N+ a-Si film 234, and a photoresist 230 are formed in sequence on the base substrate 22.

In step S2, the photoresist 230 is exposed and developed, and specifically, the photoresist 230 is exposed and developed using a dual-tone mask plate (a half-tone mask plate or a gray-tone mask plate). The photoresist 230 in the area corresponding to the thin film transistor and in the area corresponding to the data line (the areas other than G2 in the figure) is retained, and the thickness of the photoresist 230 in the area corresponding to the source and drain electrodes of the thin film transistor (G3) and in the area corresponding to the data line (G3) is made to be larger than that of the photoresist 230 in other area G1.

In step S3, the first metal film 271, the insulating film 281, the second metal film 233, and the N+ a-Si film 234 which are exposed are etched to form a structure as shown in FIG. 10, and the pattern of the black matrix is formed at the time. During etching, the exposed N+ a-Si film 234 is etched firstly by a dry etching method, the second metal film 233 is etched then by a wet etching method, next the insulating film 281 is etched by a dry etching method, and finally the first metal film 271 is etched by a wet etching method.

In step S4, the photoresist 230 is ashed to retain only the photoresist 230 corresponding to the source and drain electrode area G3 and the data line area G3.

In step S5, the second metal film 233 and the N+ a-Si film 234 which are exposed are etched to form patterns of the source and drain electrodes, the N+ a-Si film 234 and the data line, that is, the structure in FIG. 12. During etching, the exposed N+ a-Si film 234 is etched firstly by a dry etching method, and then the second metal film 233 is etched by a wet etching method.

In step S6 (not shown), patterns including an active layer (a-Si section), a gate insulating layer, a gate electrode, a gate line, a passivation layer, and a pixel electrode are formed on the basis of FIG. 12, to form a final array substrate structure. The forming way thereof is similar to that for a conventional substrate, and will not be described here.

In the above manufacturing process, the black matrix, the insulating spacing layer, the source and drain electrodes, and the N+ a-Si are formed in one mask process. The manufacturing procedures are saved.

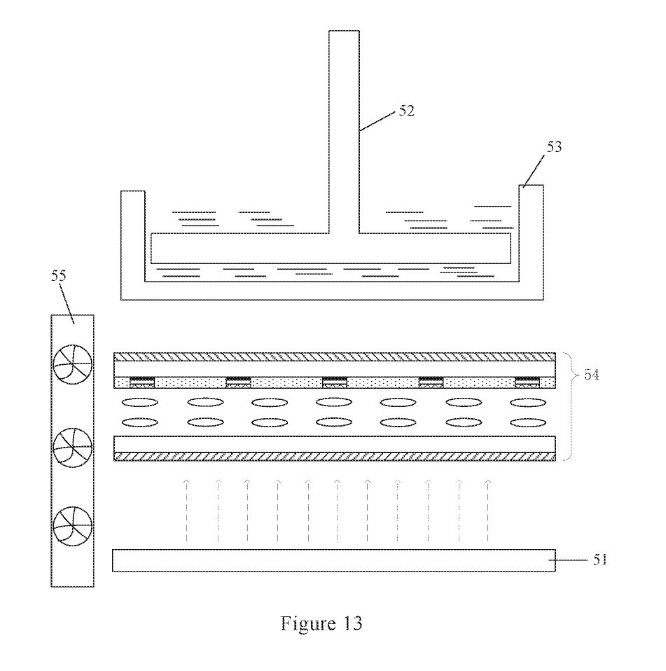

FIG. 13 is a schematic structural diagram of a 3D printing system according to embodiments of the present disclosure. The 3D printing system may include a backlight source, a lift rod pallet, a transparent reservoir, and a light control device described above. A light emitted by the backlight source is irradiated to the transparent reservoir through the light control device to form a print product. The lift rod pallet is located in the transparent reservoir to move the print product.

In the embodiment of the present disclosure, as shown in FIG. 13, the 3D printing system includes a backlight source 51, a lift rod pallet 52, a transparent reservoir 53, and a light control device 54 described above. A light emitted by the backlight source 51 is irradiated to the transparent reservoir 53 through the light control device 54. The lift rod pallet 52 is located in the transparent reservoir 53.

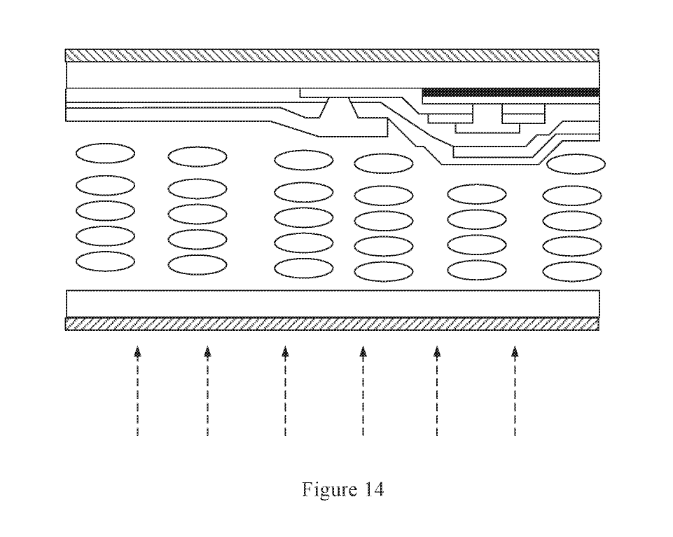

FIG. 14 is a schematic diagram of the incident light of one pixel in the 3D printing system in FIG. 13. Since the opposing substrate of the light control device 54 is a transparent colorless substrate, if light is emitted from the opposing substrate, it will be diverged with a certain degree. Therefore, as shown in FIG. 14, in order to control the light-irradiated area more precisely, a side of the array substrate of the light control device 54 is the light exit side, and a side of the opposing substrate is the light entrance side. With the pixel structure and the black matrix on the array substrate, light irradiated area may be more accurate. Since light is irradiated in from the opposing substrate, a thin film transistor with a top gate structure is used. The top gate functions to block light, so as to avoid the influence of light illumination on the active layer of the thin film transistor. Of course, a bottom gate type of a thin film transistor can also be used, and at this time, one more light blocking layer is required. The structure thereof may be slightly more complex.

Since it is necessary to cure the polymerizable material, the backlight source 51 may emit ultraviolet light.

The 3D printing system may further include a cooling device 55, such as a fan, for cooling the light control device 54.

A three-dimensional CAD physical data model or curve surface data model file of the product is firstly converted into a light-cured stereo lithography document format (referred as .stl) when performing 3D printing. Then a corresponding software is used to extract from the .stl file a series of layers with a set thickness, and then information of each of the layers forms a two-dimensional data graphic that is transmitted to a computer. After the image processing (the area where the shape is displayed is set to white and the non-display area is set to black), the signal corresponding to the pattern required for each layer is inputted to the light control device 54. The desired image is directly projected by the light control device 54 onto the polymerizable liquid material in the transparent reservoir 53 for exposure and curing to form a print product.

In a specific print, an [[use]] amount of a first layer of the polymerizable liquid material is injected into the transparent reservoir 53, and the lift rod pallet 52 is lowered to contact the polymerizable liquid material. The computer transmits the signal corresponding to the first layer to the light control device 54 for curing the area where the polymeric liquid material is irradiated. After the curing, the lift rod pallet 52 is lifted, and the cured pattern is lifted along with the lift rod pallet 52 (the printing of the first layer is finished). Then, an use amount of the next layer of the polymeric liquid material is injected, to make the polymeric liquid material in the transparent reservoir 53 reach the use amount of the next layer. The second layer is printed as described above. The process is repeated until the printing of all layers is finished, and a stacking processing is performed at the same time, until the printing of the entire part is finished.

The above embodiments are merely illustrative of the present disclosure and are not intended to limit the present disclosure, and various changes and modifications may be made by those of ordinary skill in the art without departing from the spirit and scope of the disclosure. Therefore, all equivalent technical solutions are also within the scope of the present disclosure, and the scope of patent protection of the present disclosure is defined by the claims.

1. A light control device for 3D printing of a selected area curing shaping of light-cured liquid material, comprising:
a first polarizing plate;
an array substrate;
liquid crystals;
an opposing substrate; and
a second polarizing plate which are arranged in sequence;
wherein the array substrate comprises a base substrate, a pixel array, and a black matrix formed on the base substrate; and
wherein the black matrix is formed at least in an area corresponding to a thin film transistor in the pixel array.

2. The light control device according to claim 1, wherein the black matrix is formed on a surface of the base substrate facing the opposing substrate, and is made of a metallic material.

3. The light control device according to claim 2, wherein the thin film transistor has a top gate structure and is formed above the black matrix and wherein an insulating spacing layer is provided between the black matrix and the thin film transistor.

4. A manufacturing method for a light control device comprising:
forming an array substrate including a base substrate, a pixel array, and a black matrix, such that the black matrix is formed at least in an area corresponding to a thin film transistor in the pixel array;
arranging the array substrate and an opposing substrate opposite one another to form a cell, filling the cell with liquid crystals, and sealing the cell; and
forming a first polarizing plate on a surface of the array substrate facing away from the opposing substrate, and forming a second polarizing plate on a surface of the opposing substrate facing away from the array substrate.

5. The manufacturing method for a light control device according to claim 4, wherein the step of forming an array substrate comprises:
forming in sequence, on the base substrate, a first metal film, an insulating film, a second metal film, and a photoresist;
exposing and developing the photoresist, to retain the photoresist in an area corresponding to the thin film transistor and a data line, and make a thickness of the photoresist in the area corresponding to source and drain electrodes of the thin film transistor and the data line greater than the thickness of the photoresist in other areas;
etching the first metal film, the insulating film, and the second metal film which are exposed to form a pattern of the black matrix;
ashing the photoresist, to leave only the photoresist in the area corresponding to the source and drain electrodes and the data line;
etching the second metal film, which is exposed to form patterns of the source and drain electrodes and the data line; and
forming patterns of an active layer, a gate insulating layer, a gate electrode, a gate line, a passivation layer, and a pixel electrode.

6. The manufacturing method for a light control device according to claim 4, wherein the step of forming an array substrate comprises:
forming in sequence, on the base substrate, a first metal film, an insulating film, a second metal film, an N+ a-Si film, and a photoresist;
exposing and developing the photoresist, to retain the photoresist in an area corresponding to the thin film transistor and a data line, and make the thickness of the photoresist in the area corresponding to the source and drain electrodes of the thin film transistor and the data line greater than the thickness of the photoresist in the other areas;
etching the first metal film, the insulating film, the second metal film, and the N+ a-Si film, which are exposed to form a pattern of the black matrix;
aching the photoresist, to leave only the photoresist in the area corresponding to the source and drain electrodes and the data line;
etching the second metal film and the N+ a-Si film, which are exposed to form patterns of the source and drain electrodes, an N+ a-Si layer, and the data line; and
forming patterns of an active layer, a gate insulating layer, a gate electrode, a gate line, a passivation layer, and a pixel electrode.

7. A 3D printing system comprising a backlight source, a lift rod pallet, a transparent reservoir, and a light control device of claim 1, wherein a light emitted by the backlight source is irradiated to the transparent reservoir through the light control device to form a print product, and wherein the lift rod pallet is located in the transparent reservoir to move the print product.

8. The 3D printing system according to claim 7, wherein a side of the array substrate of the light control device is the light exit side, and a side of the opposing substrate is the light entrance side.

9. The 3D printing system according to claim 7, wherein the backlight source emits ultraviolet light.

10. The 3D printing system according to claim 7, further comprising a cooling device for cooling the light control device.

11. The 3D printing system according to claim 7, wherein the black matrix is formed on a surface of the base substrate facing the opposing substrate, and is made of a metallic material.

12. The 3D printing system according to claim 7, wherein the thin film transistor has a top gate structure and is formed above the black matrix, and wherein an insulating spacing layer is provided between the black matrix and the thin film transistor.

13. The 3D printing system according to claim 8, further comprising a cooling device for cooling the light control device.

14. The 3D printing system according to claim 9, further comprising a cooling device for cooling the light control device.
